(19) United States
(12) Patent Application Publication
(10) Pub. No.: US 2026/0061515 A1
(43) Pub. Date: Mar. 5, 2026

(54) LASER BEAM PROCESSING APPARATUS AND METHOD FOR CUTTING OBJECTS USING THE SAME

(71) Applicant: DAEKHON CORPORATION CO., LTD., Seoul (KR)

(72) Inventors: Ji Hyun HWANG, Seongnam-si, Gyeonggi-do (KR); Ji Hong KIM, Hwaseong-si, Gyeonggi-do (KR); Dong Yun SHIN, Pyeongtaek-si, Gyeonggi-do (KR)

(73) Assignee: DAEKHON CORPORATION CO., LTD., Seoul (KR)

(21) Appl. No.: 19/105,534

(22) PCT Filed: Aug. 22, 2023
(86) PCT No.: PCT/KR2023/012441

§ 371 Date: Feb. 21, 2025

(30) Foreign Application Priority Data
Aug. 23, 2022 (KR) 10-2022-0105788

(51) Int. Cl. B23K 26/06; B23K 26/38

(52) U.S. Cl. CPC B23K 26/0648; B23K 26/38

(57) ABSTRACT

The present disclosure relates to a laser processing apparatus that forms a ring beam with a uniform energy distribution and outputs a laser beam with a long focal depth and small focal size. The laser processing apparatus may include: a housing part having an incident hole and an output hole; an aperture part installed inside the housing part below the incident hole, which adjusts the size of the incident beam passing through the incident hole; a multi-focus diffractive lens part installed inside the housing part below the aperture part, which deflects the incident beam along the optical axis in multiple orders, simultaneously diffracting the deflected beam to form a circular beam; a multilayer focus lens part installed inside the housing part below the multi-focus diffractive lens part, which focuses the beam that has passed through the multi-focus diffractive lens part.

### TECHNICAL FIELD

The present invention pertains to the technical field related to a laser processing apparatus capable of precisely cutting thick glass.

### BACKGROUND ART

Glass cutting has attracted much attention in the flat panel display and smart electronics industry markets. The glass cutting process should have high process efficiency, low residual heat, and a smooth cut surface. Additionally, the glass cutting process should be efficient in terms of energy and material.

An axicon lens-based Bessel beam optical apparatus, as shown in FIG. 1, is widely used in the glass cutting process. This apparatus generates nonlinear optical absorption proportional to the intensity of the incident beam in a medium with almost no linear absorption, thus enabling processing. This offers the advantage of effectively delivering energy to a narrow area.

However, the axicon lens-based Bessel beam optical apparatus has a short depth of focus (DOF). To extend the depth of focus, a large-angle axicon lens must be installed, leading to an increase in the overall size of the module.

Moreover, the axicon lens-based Bessel beam optical apparatus cannot precisely control the intensity of the beam, resulting in problems like not cleanly cutting through thick objects and causing micro-cracks on the surface of the object.

In other words, this apparatus can degrade the quality of object processing.

[Prior Art Document] Republic of Korea Patent Registration No. 10-2251985 (Publication Date: May 17, 2021)

### DETAILED DESCRIPTION OF THE INVENTION

### Technical Problem

Therefore, the present invention aims to solve the problems associated with existing axicon lens-based Bessel beam processing apparatus, namely the inability to finely adjust cutting thickness and the creation of micro-cracks on the surface of the object, thereby degrading processing quality.

The problems that the present invention aims to solve are not limited to those mentioned above, and other unmentioned technical problems will become clear to those skilled in the art from the following description.

### Technical Solution

To achieve the above objectives, the laser processing apparatus according to the present invention includes: a housing part having an accommodation space inside, with an entry hole at one end and an output hole at the other end; an aperture part installed inside the housing part below the entry hole to adjust the size of the incident beam passing through the entry hole; a multi-focal diffractive lens part installed below the aperture part inside the housing part for bending the incident beam into multiple orders along the optical axis, simultaneously diffracting the deflected beams to form a circular beam (Ring Beam); and a multilayer focusing lens part installed below the multi-focal diffractive lens part inside the housing part to focus the beam that has passed through the multi-focal diffractive lens part.

The laser processing apparatus of the present invention may further include a first protective window part installed below the entry hole in the accommodation space of the housing part, and a second protective window part installed between the multilayer focusing lens part and the output hole inside the housing part.

Another method of processing an object using the laser processing apparatus of the present invention to achieve the above objectives includes: (A) Preparing a laser processing apparatus which includes a housing part with an internal accommodation space, an entry hole at one end, and an output hole at the other end, an aperture part installed below the entry hole inside the housing part for adjusting the size of the incident beam, a multi-focal diffractive lens part installed below the aperture part inside the housing part for bending the incident beam into multiple orders along the optical axis, diffracting the deflected beams simultaneously to form a circular beam (Ring Beam), and a multilayer focusing lens part installed below the multi-focal diffractive lens part inside the housing part for focusing the beam; (B) Installing the laser processing apparatus below a laser beam output apparatus that outputs a laser beam; and (C) Positioning an object below the laser processing apparatus.

### Advantages of the Invention

The laser processing apparatus of the present invention can form a ring beam with uniform energy distribution, output a laser beam with a long depth of focus, and a small focus size.

This apparatus can cut through the deep surfaces of an object with such high-power beams. Additionally, it can reduce the intensity of diffracted beams of orders other than zero, output laser to exact locations without damaging surrounding areas, thus processing the object.

Especially, the laser processing apparatus of this invention has fewer components for processing the incident beam and a shorter beam output distance, allowing for miniaturization.

### BRIEF DESCRIPTION OF THE DRAWINGS

FIG. 1 is a perspective view of an existing axicon lens-based Bessel beam optical apparatus.

FIG. 2 is a perspective view of the laser processing apparatus of the present invention.

FIG. 3 is a cross-sectional view of the laser processing apparatus of the present invention taken along line II-II′.

FIG. 4 is a diagram comparing the durability structure of the existing axicon lens-based Bessel beam optical apparatus of FIG. 1 with the laser processing apparatus of FIG. 3.

FIG. 5 is a diagram showing the state where the incident beam is processed and output from the existing axicon lens-based Bessel beam optical apparatus of FIG. 1.

FIG. 6 shows the state of the beam output to the object from the existing axicon lens-based Bessel beam optical apparatus of FIG. 5.

FIG. 7 illustrates the state where the beam is processed by the laser processing apparatus of the present invention shown in FIG. 2.

FIG. 8 shows the laser beam formed by the multi-focal diffractive lens part in FIG. 2.

FIG. 9 illustrates the ring beam and spot beam after passing through the diffractive lens part and the multilayer focusing lens of the laser processing apparatus of FIG. 2.

FIG. 10 shows the state of the beam output to the object from the laser processing apparatus of FIG. 9.

FIG. 11 gives a detailed view of the state of the beam output to the object from the laser processing apparatus of FIG. 10.

FIG. 12 is a flowchart of a method for processing an object using the laser processing apparatus of the present invention.

### BEST MODE FOR CARRYING OUT THE INVENTION

The advantages and features of the present invention, as well as the means for achieving them, will become apparent upon reference to the embodiments described in detail below in conjunction with the accompanying drawings. However, the present invention is not limited to the embodiments disclosed herein. The present invention can be modified in various forms.

The various drawings and detailed descriptions provided in this specification are intended to make the disclosure of the present invention complete and to convey the scope of the invention to those skilled in the art. Only the claims define the scope of the invention.

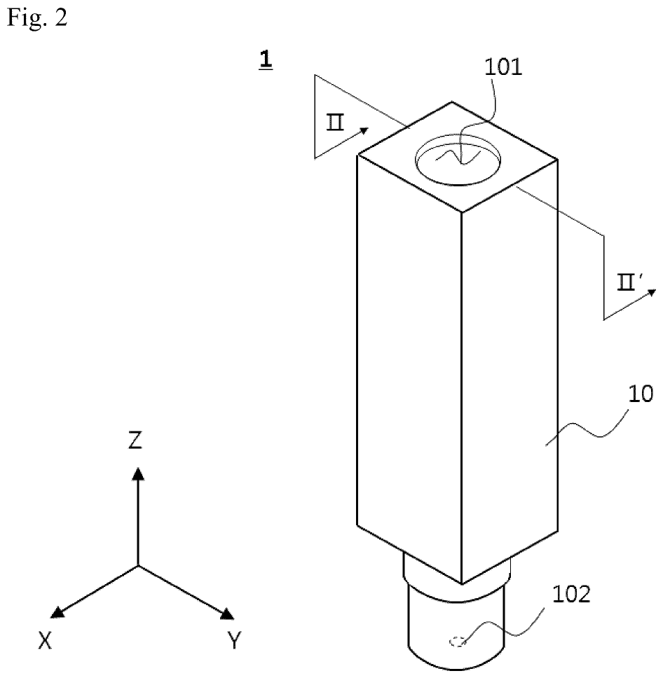

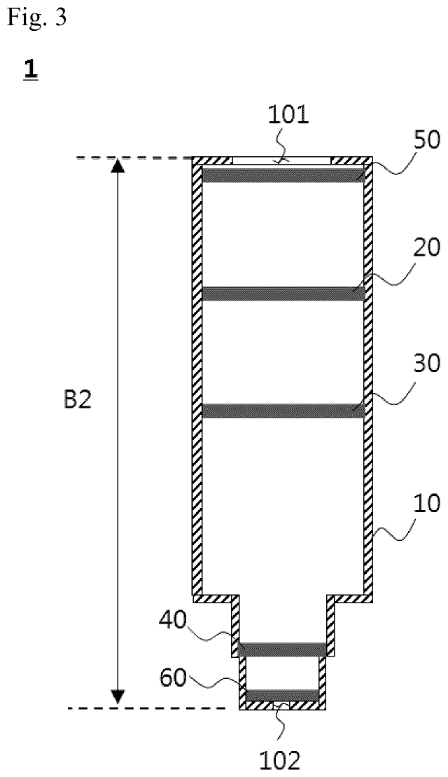

Hereinafter, with reference to FIGS. 2 and 3, an overview of the laser processing apparatus will be described to simplify and clarify the explanation of the present invention.

FIG. 2 is a perspective view of the laser processing apparatus of the present invention, and FIG. 3 is a cross-sectional view of the same apparatus taken along line II-II′.

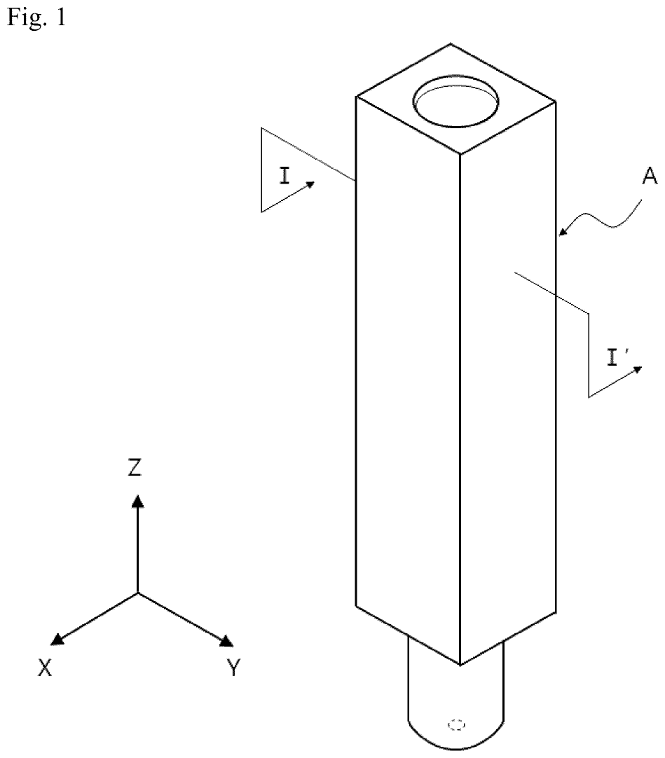

The laser processing apparatus (1) forms a ring beam with uniform energy distribution, has a long depth of focus (DOF), and outputs a laser beam with a small focus size. Such a laser beam can reach deep into the object, allowing the laser processing apparatus (1) to cut through to the deep surfaces of the object smoothly. Furthermore, the laser processing apparatus (1) can reduce the intensity of non-zero order diffracted beams to output the laser at precise locations without damaging the surrounding areas, thus cutting the object. Especially, the laser processing apparatus (1) has fewer components for processing the incident beam compared to the existing axicon lens-based Bessel beam optical apparatus shown in FIG. 1, with a shorter beam output distance, allowing the apparatus to be formed in a smaller size.

The laser processing apparatus (1) with such features includes a housing part (10), an aperture part (20), a multi-focal diffractive lens part (30), and a multilayer focusing lens part (40). Additionally, the apparatus may include a first protective window part (50) and a second protective window part (60) installed at one end and the other end of the housing part (10), respectively.

Herein, each component of the laser processing apparatus (1) will be described in detail.

The housing part (10) serves as the case of the laser processing apparatus (1). This housing part (10), as shown in FIGS. 2 and 3, can be formed with a structure where a part is a rectangular parallelepiped and a cylindrical part communicates with the lower end of the rectangular parallelepiped. The height of such a housing part (10) can be formed as ‘B2’, as depicted in FIG. 3.

Both the rectangular parallelepiped and the cylindrical part of the housing part (10) are formed as hollow structures. An entry hole (101) is perforated at one end of the rectangular parallelepiped, and an output hole (102) is perforated at the other end of the cylindrical part. Inside the rectangular parallelepiped and the cylindrical part, the aperture part (20), the multi-focal diffractive lens part (30), the multilayer focusing lens part (40), and the first and second protective window parts (50, 60) are installed.

First, the first protective window part (50) is installed below the entry hole (101) and above the aperture part (20). This first protective window part (50) blocks foreign substances from entering inside the housing part (10) from the outside, thereby keeping the interior clean. Additionally, it can protect the aperture part (20), the multi-focal diffractive lens part (30), and the multilayer focusing lens part (40) from noise beams.

The aperture part (20) is an apparatus that limits the amount of light entering the optical system. The aperture part (20) is installed in the housing part (10) and includes a frame module with holes and an aperture module installed on the frame module to open and close the holes. The aperture part (20) adjusts the size of the incident beam that has passed through the entry hole (101) by opening and closing the aperture module.

The multi-focal diffractive lens part (30) bends the incident beam into multiple orders along the optical axis, simultaneously diffracting the deflected beams to form a circular beam (Ring Beam). Here, the multi-focal diffractive lens part (30) generates diffraction of the laser beam according to the pattern on its surface. That is, the multi-focal diffractive lens part (30) can form a laser beam based on the pattern formed on it.

The multi-focal diffractive lens part (30) reduces the intensity of diffracted beams of orders other than zero, forming a circular beam (Ring Beam). This multi-focal diffractive lens part (30) is installed below the aperture part (20) inside the housing part (10). The multilayer focusing lens part (40) is installed below the multi-focal diffractive lens part (30) inside the housing part (10) to focus the beam that has passed through the multi-focal diffractive lens part (30).

The second protective window part (60) is installed below the multilayer focusing lens part (40) and above the output hole (102). This second protective window part (60) blocks foreign substances from entering inside the housing part (10) from the outside.

The first protective window part (50) and the second protective window part (60) of the present invention prevent dust from entering inside the housing part (10), keeping the interior clean. Moreover, they prevent situations where the laser beam is diffracted by foreign substances.

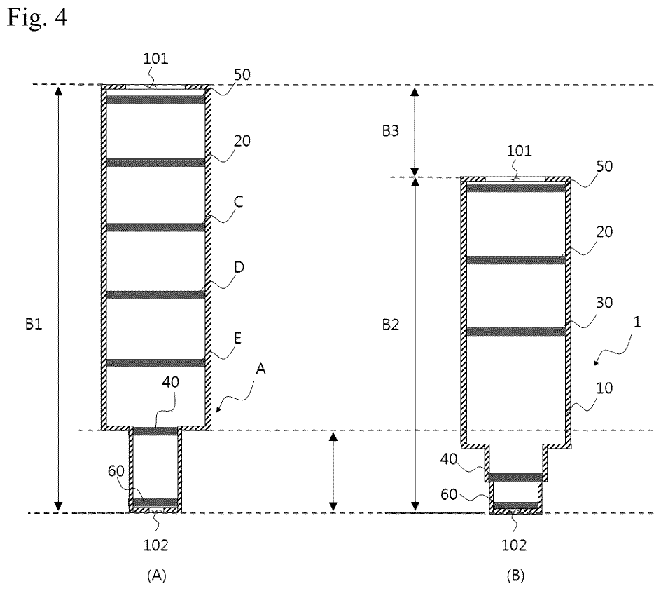

Hereinafter, with reference to FIGS. 4 to 11, the structure and features of the laser processing apparatus of the present invention will be described in detail by comparing it with the existing axicon lens-based Bessel beam optical apparatus.

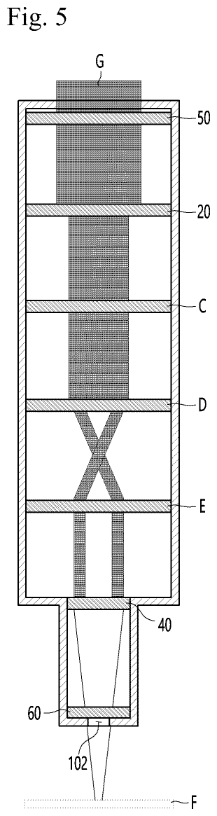

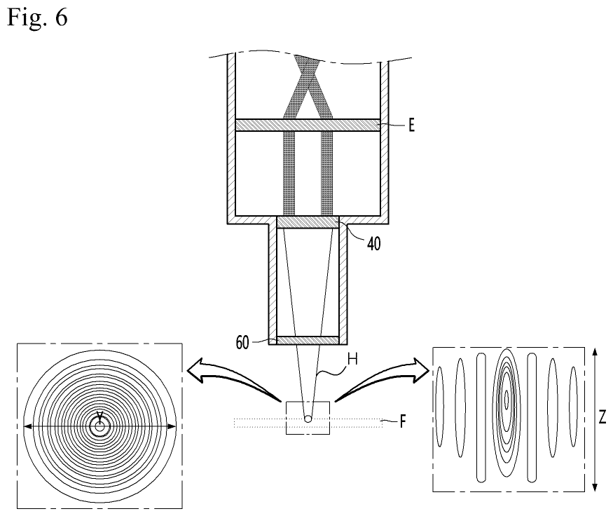

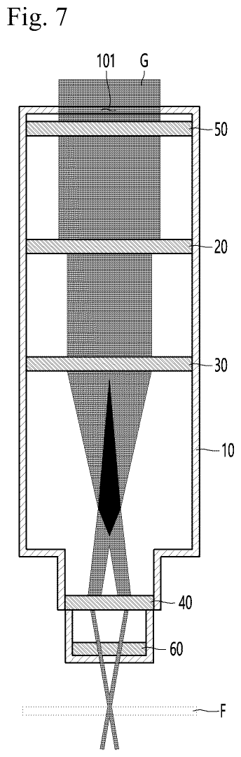

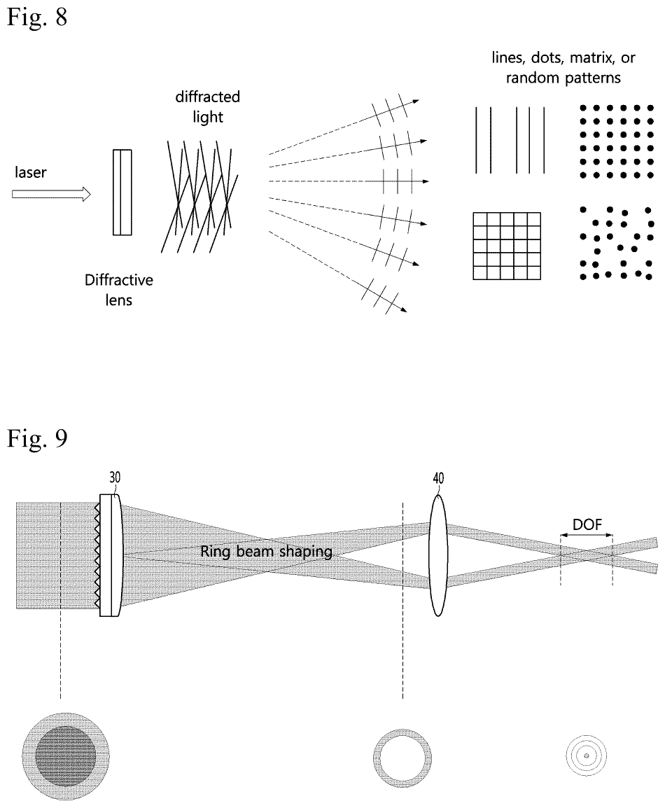

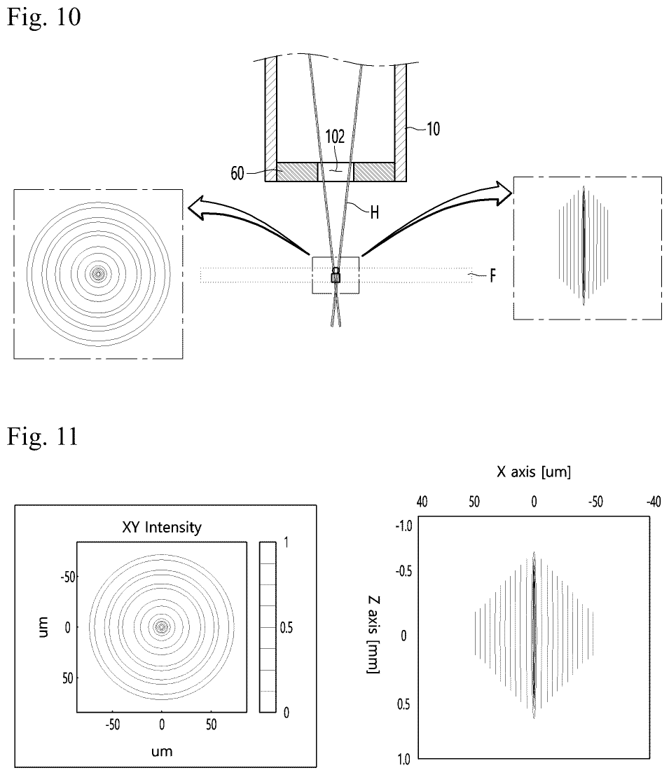

FIG. 4 is a diagram comparing the durability structure of the existing axicon lens-based Bessel beam optical apparatus of FIG. 1 with the laser processing apparatus of FIG. 3, FIG. 5 illustrates the state where the incident beam is processed and output from the existing axicon lens-based Bessel beam optical apparatus of FIG. 1, FIG. 6 shows the state of the beam output to the object from the apparatus of FIG. 5, FIG. 7 depicts the condition of the beam being processed by the laser processing apparatus of the present invention from FIG. 2, FIG. 8 shows the laser beam formed by the multi-focal diffractive lens part of FIG. 2, FIG. 9 illustrates the ring beam and spot beam after passing through the diffractive lens part and the multilayer focusing lens of the laser processing apparatus of FIG. 2. FIG. 10 shows the state of the beam output to the object from FIG. 9, and FIG. 11 provides a detailed view of the state of the beam output to the object from FIG. 10.

The existing axicon lens-based Bessel beam optical apparatus (A) has a relatively long height compared to the laser processing apparatus (1), as shown in FIG. 4. That is, the existing axicon lens-based Bessel beam optical apparatus (A) has a larger structure than the laser processing apparatus (1); for example, its height can be formed as ‘B1’ as depicted in FIG. 4.

At the top of the housing part of the existing axicon lens-based Bessel beam optical apparatus (A), an entry hole (101) can be formed, and at the bottom, an output hole (102) can be formed. Inside the housing part (10), the same first protective window part (50), second protective window part (60), aperture part (20), and multilayer focusing lens part (40) as installed in the laser processing apparatus (1) are included.

Also, a filter (C), an axicon lens (D), and a delay lens (E) which are not installed inside the laser processing apparatus (1) are included. Here, the first protective window part (50) is placed between the entry hole (101) and the aperture part (20), the aperture part (20) is installed between the first protective window part (50) and the filter (C), and the filter (C) is installed between the aperture part (20) and the axicon lens (D). Here, the filter (C) enhances brightness by allowing only specific wavelengths to pass through.

The axicon lens (D) is installed between the filter (C) and the delay lens (E) to form a circular beam. The delay lens (E) is installed between the axicon lens (D) and the multilayer focusing lens part (40) to flatten the deformed circular beam, preventing it from spreading outwards.

Thus, the existing axicon lens-based Bessel beam optical apparatus (A) includes more components than the laser processing apparatus of the present invention. Moreover, as shown in FIG. 11, the existing axicon lens-based Bessel beam optical apparatus (A) has a short depth of focus (DOF), leading to uneven energy intensity along the Z-axis, with only the laser beam intensity touching the object's surface being strong, and the laser beam not reaching deep into the object. Additionally, as shown in FIG. 6, the focal size of the laser beam output to the object (F) in the existing apparatus is large, causing damage around the area where the laser is output, and the energy intensity decreases gradually along the Z-axis due to the short depth of focus.

To output a laser beam with a long depth of focus from the existing axicon lens-based Bessel beam optical apparatus (A), a large axicon lens (D) must be installed, which increases the size of the optical apparatus.

On the other hand, the laser processing apparatus (1) of the present invention, as shown in FIG. 4, is formed with a relatively short height compared to the existing axicon lens-based Bessel beam optical apparatus (A). That is, the laser processing apparatus (1) has a smaller structure; for example, its height can be formed as ‘B2’, which is ‘B3’ shorter than ‘B1’ as depicted in FIG. 4.

The laser processing apparatus (1) of the present invention, unlike the existing axicon lens-based Bessel beam optical apparatus (A), includes inside the housing part (10) the first protective window part (50), the second protective window part (60), the aperture part (20), the multilayer focusing lens part (40), and the multi-focal diffractive lens part (30). Here, the multi-focal diffractive lens part (30) can diffract the laser beam according to the pattern on its surface to form a beam, as shown in FIG. 8. This multi-focal diffractive lens part (30) can form a ring beam with a long depth of focus and a small spot size over a short distance.

This multi-focal diffractive lens part (30) exhibits the characteristics shown by the axicon lens (D) and the delay lens (E) included in the existing axicon lens-based Bessel beam optical apparatus (A) and can replace them.

The laser processing apparatus (1) of the present invention outputs a laser beam with a long depth of focus (DOF) and uniform energy intensity along the Z-axis, as shown in FIG. 11, allowing the laser beam to reach deep into the object.

Additionally, as shown in FIG. 7, the laser processing apparatus (1) reduces the size of the incoming beam (G) through the aperture part (20), then directs this reduced laser beam to the multi-focal diffractive lens part (30). Subsequently, as shown in FIG. 8, it bends the reduced laser beam into multiple orders, simultaneously diffracts the deflected beams to form a circular beam (Ring Beam), and focuses this formed circular beam through the multilayer focusing lens part (40) to output a laser beam (H) with a small diameter, i.e., a spot beam.

At this moment, as shown in FIGS. 10 and 11, the laser processing apparatus (1) outputs a spot beam (H) that is small in size but high in intensity.

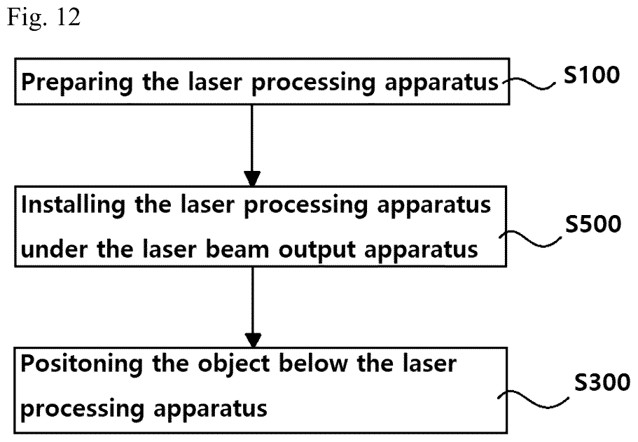

Hereinafter, with reference to FIG. 12, a method for processing an object based on the above-described laser processing apparatus will be explained.

FIG. 12 is a flowchart of a method for processing an object using the laser processing apparatus of the present invention.

The laser processing apparatus for processing an object can be the laser processing apparatus (1) of the present invention. Therefore, to keep the explanation concise, the detailed description of the laser processing apparatus is replaced with the previously described explanation of the laser processing apparatus (1).

The method for processing an object using a laser processing apparatus involves delivering laser beams from one side of the object to the other through the laser processing apparatus (1), uniformly cutting the object, and enhancing the strength of the cut surface.

This method for processing an object using a laser processing apparatus proceeds through the steps of: (A) Preparing the laser processing apparatus (1) (Step S100), (B) Installing the laser processing apparatus (1) below a laser beam output apparatus that outputs a laser beam (Step S200), and (C) Positioning an object below the laser processing apparatus (1) (Step S300).

This method can accurately cut only the intended part of the object, with uniform intensity, preventing micro-cracks in the object, thus improving the quality of the processed object.

While the embodiments of the present invention have been described with reference to the accompanying drawings, those skilled in the art in the technical field to which the present invention belongs can understand that the invention can be implemented in other specific forms without changing its technical spirit or essential features. Therefore, the embodiments described above are to be considered in all respects as illustrative and not restrictive.

### EXPLANATION OF SYMBOLS

1: Laser Processing Apparatus
10: Housing Part
101: Entry Hole 102: Output Hole
20: Aperture Part 30: Multi-Focal Diffractive Lens Part
40: Multilayer Focusing Lens Part 50: First Protective Window Part
60: Second Protective Window Part

1. A laser processing apparatus comprising:
a housing part (10) having an internal accommodation space, with an entry hole (101) at one end and an output hole (102) at the other end;
an aperture part (20) installed inside the housing part (10) below the entry hole (101) to adjust the size of the incident beam passing through the entry hole (101);
a multi-focal diffractive lens part (30) installed inside the housing part (10) below the aperture part (20) for bending the incident beam into multiple orders along the optical axis, simultaneously diffracting the deflected beams to form a circular beam (Ring Beam); and
a multilayer focusing lens part (40) installed inside the housing part (10) below the multi-focal diffractive lens part (30) for focusing the beam that has passed through the multi-focal diffractive lens part (30).

2. The laser processing apparatus according to claim 1, further comprising:
a first protective window part (50) installed below the entry hole (101) in the accommodation space of the housing part (10); and
a second protective window part (60) installed between the multilayer focusing lens part (40) and the output hole (102) inside the housing part.

3. A method of processing an object using a laser processing apparatus, comprising the steps of:
(A) preparing a laser processing apparatus (1) which includes a housing part (10) with an internal accommodation space, an entry hole (101) at one end, and an output hole (102) at the other end, an aperture part (20) installed inside the housing part (10) below the entry hole for adjusting the size of the incident beam, a multi-focal diffractive lens part (30) installed below the aperture part inside the housing part for bending the incident beam into multiple orders along the optical axis, diffracting the deflected beams simultaneously to form a circular beam (Ring Beam), and a multilayer focusing lens part (40) installed below the multi-focal diffractive lens part (30) inside the housing part for focusing the beam (Step S100);
(B) installing the laser processing apparatus (1) below a laser beam output apparatus that outputs a laser beam (Step S200); and
(C) positioning an object below the laser processing apparatus (1) (Step S300).
